(19) United States
(12) Patent Application Publication
(10) Pub. No.: US 2006/0104317 A1
(43) Pub. Date: May 18, 2006

(54) Multi-protocol signals processing apparatus and method for NG-SDH transponder

(76) Inventors: Joon-Hak Bang, Daejon (KR); Je-Soo Ko, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/149,796

(22) Filed: Jun. 9, 2005

(30) Foreign Application Priority Data
Nov. 17, 2004 (KR) 10-2004-0094272

(51) Int. Cl. H04J 3/02

(52) U.S. Cl. 370/538

(57) ABSTRACT

Provided are a multi-protocol signal processing apparatus for a next-generation Synchronous Digital Hierarchy (NG-SDH) transponder, and a method thereof. The multi-protocol signal processing apparatus for an NG-SDH transponder, which includes: a sub-signal processing unit for classifying and processing multi-protocol sub-signals based on kinds; an interfacing unit for making interface between the sub-signal processing unit and an optical signal generating unit the same for the multi-protocol sub-signals to use the multi-protocol sub-signals in Synchronous Digital Hierarchy (SDH) flexibly with no regard to the kinds of the multi-protocol sub-signals; and the optical signal generating unit for generating SDH optical signals by aggregating the multi-protocol sub-signals having a predetermined capacity which are transmitted through the interfacing unit into SDH signals, performing framing, and performing optical/electrical (O/E) conversion on the SDH signals in an optical module.

### FIELD OF THE INVENTION

The present invention relates to next-generation Synchronous Digital Hierarchy (NG-SDH) technology for including multi-protocol sub-signals into SDH signals based on Generic Framing Procedure (GFP) and Virtual Concatenation (Vcat) technology. More particularly, the present invention relates to a multi-protocol signal processing apparatus for an NG-SDH transponder that can include a sub-signal into an SDH signal regardless of the kind of the sub-signal by separating a sub-signal processing unit for processing multi-protocol sub-signals from a optical signal generating unit for generating 40G SDH signals and making the interface between the sub-signal processing unit and the optical signal generating unit the same for all the multi-protocol sub-signals, and a method thereof.

### DESCRIPTION OF RELATED ART

A next-generation Synchronous Digital Hierarchy (NG-SDH) is developed in an attempt to use a signal of a new format, such as a signal of an Ethernet and a signal of a Fiber Channel (FC), in existing SDH networks. As the NG-SDH technology is standardized recently, researchers have studied actively in Korea and overseas to develop chips with an NG-SDH transmission function and Multi-Service Provisioning Platform (MSPP) equipment.

The core technology of conventional method for using multi-protocol signals is Generic Framing Procedure (GFP) mapping, which is defined in a Telecommunication Standardization Sector of the International Telecommunications Union (ITU-T) recommendation G.7041. The ITU-T recommendation G.7041 defines framing standards for using signals of different formats other than the SDH, such as a signal of an Ethernet and a signal of a Fiber channel, in an SDH device.

The ITU-T recommendation G.7041 defines the GFP process largely in two methods. One is a frame-mapped GFP (GFP-F) process which frames signals, such as the Ethernet, on a frame basis, and the other is transparent GFP (GFP-T) process which receives block-coded signals such as signals of the FC, signals of enterprise system connection (ESCON) and signals of Fibre Connectivity (FICON), and continues to frame the received signals.

Another important technology is Virtual Concatenation (Vcat), technology which is differentiated from widely used contiguous concatenation. Since the Vcat technology can make signals N times as large as a 52 Mbps VC-3 or 155 Mbps VC-4 unit which is used in the SDH transmission network, it can create particular signals with a size suitable for a user signal.

FIGS. 1A and 1B, which are block diagrams showing conventional multi-protocol signal processing apparatuses, show structures for using conventional multi-protocol signals.

First, the multi-protocol signal processing apparatus of FIG. 1A uses signals based on the GFP-F technology. It receives a 10GbE optical signal, which is a multi-protocol sub-signal, performs a physical layer process, which includes a Physical Medium Dependent (PMD) process, a Physical Medium Attachment (PMA) process, and a Physical Coding Sublayer (PCS) process, in a layer 1, and extracts a Media Access Control (MAC) frame, which is a pure Ethernet signal, in a layer 2. After mapping the MAC frame to the GFP-F, the multi-protocol signal processing apparatus loads the MAC frame on a SDH signal by using a Vcat function. Herein, an STM-64 (10G SDH) framing process can be used optionally depending on cases.

FIG. 1B shows a multi-protocol signal processing apparatus using signals based on the GFP-T technology. The physical layer process in the layer 1 is the same as in the GFP-F. What is different from the GFP-F is that a 64B/65B-coded super block is generated without going through the MAC process in the layer 2. The generated super block is mapped to the GFP frame and loaded on an SDH signal also by using the Vcat function.

In order to operate an NG-SDH transponder for efficiently using multi-protocol signals for SDH signals by using the GFP and Vcat technology, it is required to develop technology for including the multi-protocol signals, such as 10G SDH, 2.5G SDH, 10GbE, 1GbE, 10GFC and 1GFC, into 40G SDH signals flexibly regardless of the kinds of the sub-signals.

### SUMMARY OF THE INVENTION

It is, therefore, an object of the present invention to provide a multi-protocol signal processing apparatus for a next-generation Synchronous Digital Hierarchy (NG-SDH) transponder that can use sub-signals for SDH signals regardless of the kind of the sub-signal by separating a sub-signal processing unit for processing a multi-protocol sub-signal from a optical signal generating unit for generating a 40G SDH signal and making the interface between the sub-signal processing unit and the optical signal generating unit the same for all the multi-protocol sub-signals, and a method thereof.

The other objects and advantages of the present invention can be understood by the following description with reference to preferred embodiments of the present invention. Also, the objects and advantages of the present invention can be realized by the means as claimed and combinations thereof.

In accordance with an aspect of the present invention, there is provided a multi-protocol signal processing apparatus for a NG-SDH transponder, which includes: a sub-signal processing unit for classifying and processing multi-protocol sub-signals based on kinds; an interfacing unit for making interface between the sub-signal processing unit and an optical signal generating unit the same for the multi-protocol sub-signals to use the multi-protocol sub-signals in Synchronous Digital Hierarchy (SDH) flexibly with no regard to the kinds of the multi-protocol sub-signals; and the optical signal generating unit for generating SDH optical signals by aggregating the multi-protocol sub-signals having a predetermined capacity which are transmitted through the interfacing unit into SDH signals, performing framing, and performing photoelectric transformation on the SDH signals in an optical module.

In accordance with another aspect of the present invention, there is provided a method for processing multi-protocol signals in a NG-SDH transponder, the method which includes the steps of: a) separating a sub-signal generating unit for processing multi-protocol sub-signals from an optical signal generating unit for generating SDH signals; b) classifying and processing the multi-protocol sub-signals based on kinds; c) making interface between the sub-signal processing unit and an optical signal generating unit the same for the multi-protocol sub-signals to use the multi-protocol sub-signals in SDH flexibly with no regard to the kinds of the multi-protocol sub-signals; and d) generating SDH optical signals by aggregating a predetermined number of the multi-protocol sub-signals which are unified in the interfacing unit into SDH signals, performing framing, and performing photoelectric transformation on the SDH signals in an optical module.

### BRIEF DESCRIPTION OF THE DRAWINGS

The above and other objects and features of the present invention will become apparent from the following description of the preferred embodiments given in conjunction with the accompanying drawings, in which:

FIGS. 1A and 1B are block diagrams showing conventional multi-protocol signal processing apparatuses;

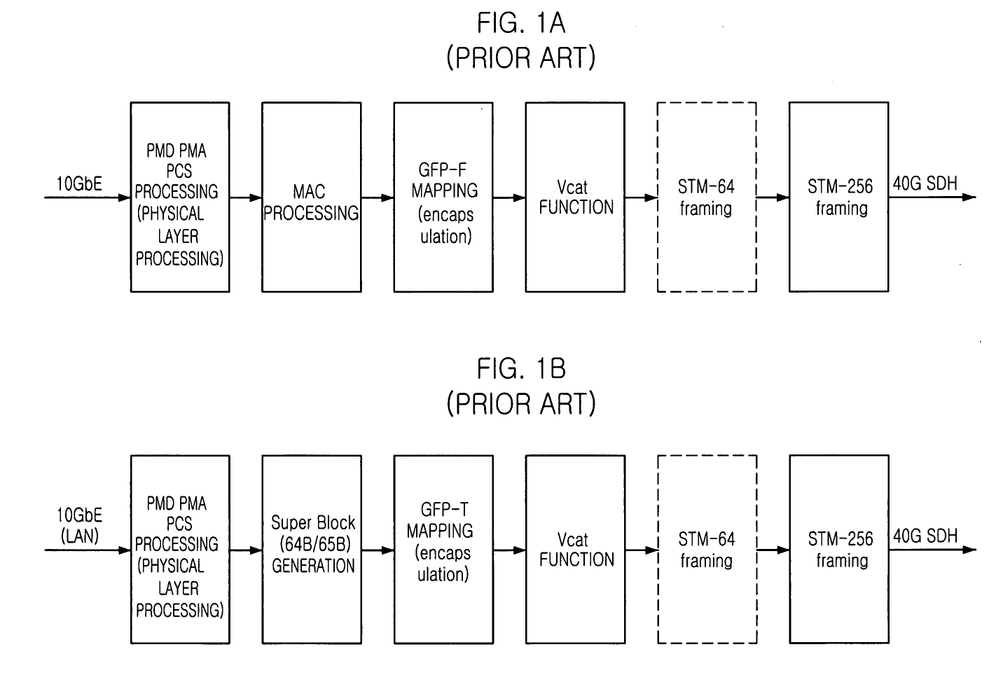

FIG. 2 is a block diagram describing a multi-protocol signal processing apparatus of a next-generation Synchronous Digital Hierarchy (NG-SDH) transponder in accordance with an embodiment of the present invention; and

FIG. 3 is a block diagram illustrating a multi-protocol signal processing apparatus of a NG-SDH transponder in accordance with an embodiment of the present invention.

### DETAILED DESCRIPTION OF THE INVENTION

Other objects and aspects of the invention will become apparent from the following description of the embodiments with reference to the accompanying drawings, which is set forth hereinafter. If it is determined that further description on prior art may unnecessarily blur the points of the present invention, the description will not be provided. Hereafter, preferred embodiments of the present invention will be described in detail with reference to the accompanying drawings.

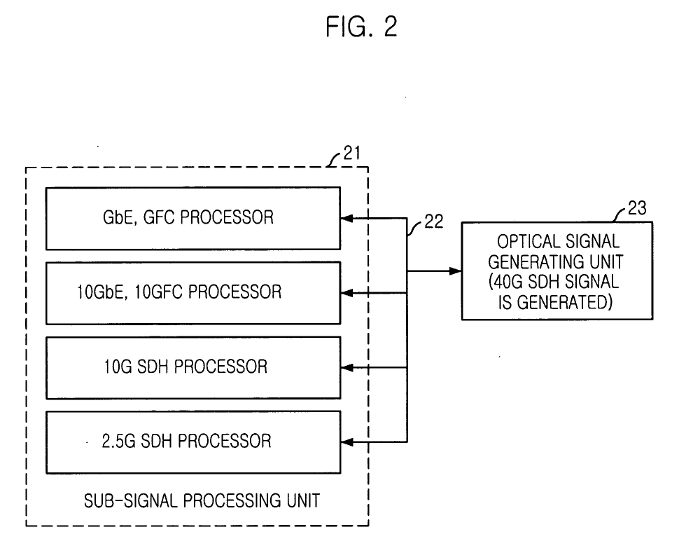

FIG. 2 is a block diagram describing a multi-protocol signal processing apparatus of a next-generation Synchronous Digital Hierarchy (NG-SDH) transponder in accordance with an embodiment of the present invention. As shown, the multi-protocol signal processing apparatus of the NG-SDH transponder comprises: a sub-signal processing unit 21 for classifying and processing multi-protocol sub-signals according to their kinds; an interfacing unit 22 for making the interface between the sub-signal processing unit 21 and an optical signal generating unit 23 the same for the multi-protocol sub-signals so that the multi-protocol sub-signals can be used in the 40G SDH without any problem regardless of the kind of the multi-protocol sub-signals; and the optical signal generating unit 23 for generating 40G SDH optical signals by framing 10G sub-signals transmitted through the sub-signal processing unit 21 based on the 40G SDH and optically converting the 40G SDH signals in a 40G optical module.

Therefore, the optical signal generating unit 23 recognizes different types of sub-signals as the signals of the same form regardless of the kinds of the sub-signals.

Hereafter, the operation of the above-described multi-protocol signal processing apparatus of the NG-SDH transponder will be described in accordance with an embodiment of the present invention.

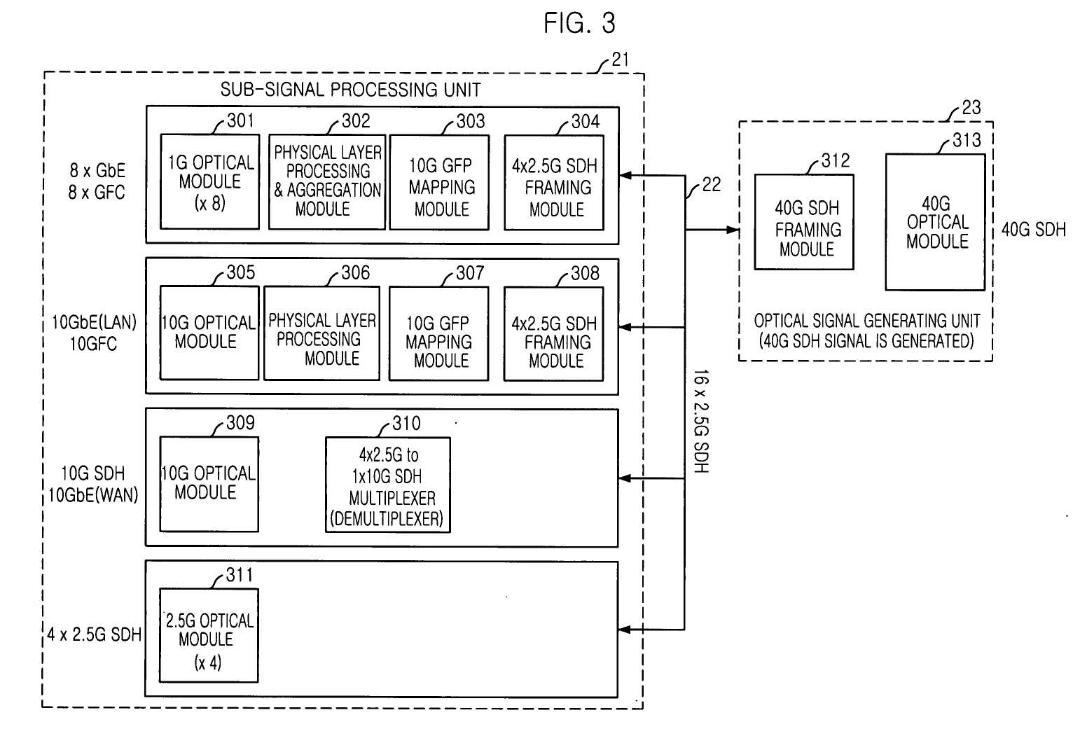

FIG. 3 is a block diagram illustrating a multi-protocol signal processing apparatus of a NG-SDH transponder in accordance with an embodiment of the present invention. As shown, in a Gigabit Ethernet or a Gigabit Fiber Channel, multi-protocol sub-signals go through an optical/electrical (O/E) conversion in a 1G optical module 301, physical layer processing and aggregation into 10G signals in a physical layer processing and aggregation module 302, GFP mapping in 10G GFP mapping module 303, and framing into four 2.5G SDH signals in 4×2.5G SDH framing module 304. Then, the obtained SDH signals are transmitted to the optical signal generating unit 23.

In a 10GFC and a 10GbE which is used for a Local Area Network (LAN), multi-protocol sub-signals go through photoelectric transformation in a 10G optical module 305, physical layer processing in a physical layer processing module 306, 10G GFP mapping in a 10G GFP mapping module 307, and framing into four 2.5G SDH signals in 4×2.5G SDH framing module 308. Then, the obtained SDH signals are transmitted to the optical signal generating unit 23.

In a 10G SDH and a 10GbE which is used for a Wide Area Network (WAN), multi-protocol sub-signals go through O/E conversion in 10G optical module 309. Since SDH signals are obtained from the O/E conversion, the SDH signals are directly demultiplexed into four 2.5G SDH in a 4x2.5G to 1x10G SDH multiplexer 310 without the physical layer process and the GFP mapping and transmitted to the optical signal generating unit 23.

Finally, as for a 2.5G SDH, multi-protocol sub-signals go through O/E conversion in a 2.5G optical module 311 and then directly transmitted to the optical signal generating unit 23. The optical signal generating unit 23 which has received the 16 2.5G SDH signals in the above frames the signals into 40G SDH signals to thereby form 40G SDH signals in 40G SDH framing module 312. Then, it generates 40G SDH optical signals by performing O/E conversion in a 40G optical module 313.

Herein, the signals that goes through the interfacing unit 22, which makes the interface between the sub-signal processing unit 21 and the optical signal generating unit 23 the same for the multi-protocol sub-signals, are unified in a form of four 2.5G SDH signals. As a result, the optical signal generating unit 23 comes to receive signals of the same form with no regard to the kinds of sub-signals.

This way, various kinds of sub-signals can be used, regardless of the kinds of the sub-signals. This signifies that the sub-signal processing unit 21 needs not be placed where it is supposed to be in conventional signal processing apparatuses. Also, the usable kinds of sub-signals are not limited to eight GbE, one 10GbE, one 10G SDH, four 2.5G SDH, but other kinds of sub-signals, such as four 10 GbE, three 10G SDH, and eight GbE, can be used as long as the total capacity summation does not exceed 40G.

As described above, the method of the present invention can be realized as a program and stored in a computer-readable recording medium, such as CD-ROM, RAM, ROM, floppy disks, hard disks, and magneto-optical disks. Since the process can be easily executed by those of ordinary skill in the art where the present invention belongs, further description will not be provided herein.

As described above, the present invention suggests an efficient structure for the NG-SDH transponder for including multi-protocol sub-signals into 40G SDH signals. The NG-SDH transponder can use multi-protocol sub-signals with no regard to the kinds of the sub-signals by separating the sub-signal processing unit 21 from the optical signal generating unit 23 and making the interface between the sub-signal processing unit 21 and the optical signal generating unit 23 the same for the multi-protocol sub-signals regardless of the kinds of the sub-signals.

The present application contains subject matter related to Korean patent application No. 2004-0094272, filed in the Korean Intellectual Property Office on Nov. 17, 2004, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A multi-protocol signal processing apparatus for a next-generation Synchronous Digital Hierarchy (NG-SDH) transponder, comprising:
a sub-signal processing means for classifying and processing multi-protocol sub-signals based on kinds;
an interfacing means for making interface between the sub-signal processing means and an optical signal generating means the same for the multi-protocol sub-signals to use the multi-protocol sub-signals in Synchronous Digital Hierarchy (SDH) flexibly with no regard to the kinds of the multi-protocol sub-signals; and
the optical signal generating means for generating SDH optical signals by aggregating the multi-protocol sub-signals having a predetermined capacity which are transmitted through the interfacing means into SDH signals, performing framing, and performing optical/electrical (O/E) conversion on the SDH signals in an optical module.

2. The multi-protocol signal processing apparatus as recited in claim 1, wherein interface between the sub-signal processing means and the interfacing means is unified in a form of a predetermined number of SDH signals, and thus the optical signal generating means recognizes the multi-protocol sub-signals as signals of the same form regardless of the kinds of the multi-protocol sub-signals, because the multi-protocol sub-signals are transmitted in a form of the SDH signals to the optical signal generating means regardless of the kinds of the multi-protocol sub-signals.

3. The multi-protocol signal processing apparatus as recited in claim 1, wherein the sub-signal processing means can be placed without limitation in position, and the sub-signal processing means can process the multi-protocol sub-signals regardless of the kinds of the sub-signals within a predetermined capacity that is affordable in the optical signal generating means.

4. The multi-protocol signal processing apparatus as recited in claim 3, wherein the sub-signal processing means frames signals of a protocol other than the SDH into SDH signals by performing Generic Framing Procedure (GFP) mapping to make the interface between the sub-signal processing means and the optical signal generating means the same for the multi-protocol sub-signals.

5. The multi-protocol signal processing apparatus as recited in claim 4, wherein the optical signal generating means generates SDH optical signals by performing O/E conversion on a predetermined number of SDH signals obtained in the interfacing means in the optical module.

6. A method for processing multi-protocol signals in a next-generation Synchronous Digital Hierarchy (NG-SDH) transponder, comprising the steps of:
a) separating a sub-signal generating unit for processing-multi-protocol sub-signals from an optical signal generating unit for generating SDH signals;
b) classifying and processing the multi-protocol sub-signals based on kinds;
c) making interface between the sub-signal processing unit and an optical signal generating unit the same for the multi-protocol sub-signals to use the multi-protocol sub-signals in SDH flexibly with no regard to the kinds of the multi-protocol sub-signals; and
d) generating SDH optical signals by aggregating a predetermined number of the multi-protocol sub-signals which are unified in the interfacing means into SDH signals, performing framing, and performing O/E conversion on the SDH signals in an optical module.

7. The method as recited in claim 6, wherein interface between the sub-signal processing unit and the interfacing unit is unified in a form of a predetermined number of SDH signals, and thus the optical signal generating unit recognizes the multi-protocol sub-signals as signals of the same protocol regardless of the kinds of the multi-protocol sub-signals, because the multi-protocol sub-signals are transmitted in a form of the SDH signals to the optical signal generating means regardless of the kinds of the multi-protocol sub-signals.

8. The method as recited in claim 6, wherein the step b) can be placed without limitation in position, and the multi-protocol sub-signals can be processed at the step b) regardless of the kinds of the sub-signals within a predetermined capacity that is affordable in the optical signal generating means.

9. The method as recited in claim 8, wherein signals of a protocol other than the SDH are framed into SDH signals at the step b) by performing Generic Framing Procedure (GFP) mapping to make the interface between the sub-signal processing means and the optical signal generating means the same for the multi-protocol sub-signals.
